(19) United States
(12) Patent Application Publication
(10) Pub. No.: US 2024/0386100 A1
(43) Pub. Date: Nov. 21, 2024

(54) Synthetic Data Quality Measurement Tool

(71) Applicant: Bank of America Corporation, Charlotte, NC (US)

(72) Inventors: Jodie Humphreys, London (GB); Ben Clarke, London (GB); Martin Kratky, London (GB)

(21) Appl. No.: 18/667,375

(22) Filed: May 17, 2024

Related U.S. Application Data
(60) Provisional application No. 63/467,644, filed on May 19, 2023.

(51) Int. Cl. G06F 21/55

(52) U.S. Cl. CPC G06F 21/554; G06F 2221/034

(57) ABSTRACT

Aspects of the disclosure relate to processing and validating synthetic data. A computing system may receive non-synthetic data and synthetic data. Based on inputting the synthetic and non-synthetic data into a plurality of machine learning models, respective data quality scores (e.g., estimated Jensen-Shannon divergence values associated with an extent to which the synthetic data is similar to the non-synthetic data) may be generated. Based on a highest data quality score meeting data quality criteria, a message may be generated. The message may comprise an indication that the synthetic data has satisfied the data quality criteria and may be sent to a second computing system that is configured to use the synthetic data to perform operations.

### CROSS-REFERENCE TO RELATED APPLICATION

This application claims the benefit of U.S. Provisional Patent Application No. 63/467,644, filed on May 19, 2023, which is fully incorporated herein by reference.

### TECHNICAL FIELD

Some aspects of the disclosure relate to automatically calculating the quality of synthetic data and/or detecting fraudulent synthetic data. Some aspects of the disclosure pertain to the automatic intake and processing of synthetic data that may be evaluated using machine learning models that are configured to determine an extent to which the synthetic data has a distribution similar to that of non-synthetic data.

### BACKGROUND

Synthetic data is used in a variety of applications including financial modelling and analysis. In some cases synthetic data may be substituted for real-world data that may not be available or restricted in order to safeguard the privacy of entities associated with the synthetic data. However, using synthetic data in lieu of real-world data may result in unexpected and sometimes inaccurate results. Further, the process of analyzing synthetic data and determining its validity can be arduous and consume a significant amount of time and computational resources. As a result, attempting to accurately evaluate and validate synthetic data may present difficulties.

### SUMMARY

Aspects of the disclosure provide technical solutions to improve the effectiveness with which synthetic data may be evaluated and processed. Further, aspects of the disclosure may be used to resolve technical problems associated with accurately evaluating and determining the quality of synthetic data as well as detecting fraudulent data.

In accordance with one or more embodiments of the disclosure, a computing system may comprise one or more processors and memory storing computer-readable instructions that, when executed by the one or more processors, cause the computing system to receive data comprising: synthetic data comprising a plurality of synthetic data samples; and non-synthetic data comprising a plurality of non-synthetic data samples. The computing system may generate, based on inputting the data into a plurality of discriminative machine learning models, a plurality of data quality scores associated with an extent to which the synthetic data is similar to the non-synthetic data. Each of the data quality scores may provide an estimate of a similarity between a distribution of the plurality of synthetic data samples and a distribution of the plurality of non-synthetic data samples. The computing system determine a highest data quality score from the plurality of data quality scores. Further, and based on the highest data quality score, the computing system may generate a message comprising an indication whether the synthetic data has satisfied one or more data quality criteria associated with validity of the synthetic data to test performance of one or more applications. The computing system may send the message to a remote computing system that uses the synthetic data to test performance of one or more applications.

In some arrangements, the computing system may generate a data quality score, of the plurality of data quality scores, by determining, based on applying a cost function to the discriminative machine learning model, a cost value associated with the discriminative machine learning model.

In some arrangements, the cost value may be a converged cost value that is determined based on applying increasing quantity of data samples to the discriminative machine learning model.

In some arrangements, the data quality score may be an estimate of a Jensen-Shannon divergence value for the synthetic data and the non-synthetic data. The data quality score may be positively correlated with a probability that the synthetic data is not similar to the non-synthetic data.

In some arrangements, the computing system may iteratively train a discriminative machine learning model, of the plurality of discriminative machine learning models, based on the synthetic data samples and the non-synthetic data samples.

In some arrangements, the non-synthetic data may be based on one or more real world financial transactions, one or more consumer real world consumer account details, or one or more real world consumer credit histories.

In some arrangements, the computing system may generate, based on inputting the non-synthetic data into one or more generative machine learning models, the synthetic data. The synthetic data and the non-synthetic data may comprise multidimensional tabular data.

In some arrangements, each of the plurality of data quality scores may correspond to a lower bound of an actual Jensen-Shannon divergence value associated with the synthetic data and the non-synthetic data.

In some arrangements, the synthetic data satisfying the one or more data quality criteria may comprise the highest data quality score being below a threshold data quality score.

In some arrangements, the computing system may perform, using the synthetic data and based on the synthetic data satisfying the one or more data quality criteria, one or more operations for simulation modelling or fraud detection.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative computing environment for automated processing and validation of synthetic data in accordance with one or more aspects of the disclosure;

FIG. 2 depicts an illustrative computing platform for automated processing and validation of synthetic data in accordance with one or more aspects of the disclosure;

FIG. 3 depicts an illustrative artificial neural network on which a machine learning algorithm may be implemented in accordance with one or more aspects of the disclosure;

FIG. 4 depicts an illustrative method for automated processing and validation of synthetic data in accordance with one or more example embodiments; and

FIG. 5 depicts an illustrative method for training machine learning models in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of the concepts described herein may relate to devices, systems, non-transitory computer readable media, and/or methods for processing, evaluating, and/or validating synthetic data. The disclosed technology may leverage artificial intelligence (e.g., one or more machine learning models) to evaluate synthetic data and generate a data quality score that indicates the extent to which the synthetic data is similar to non-synthetic data (e.g., data based on real-world events that was not artificially generated). The use of a machine learning model to evaluate synthetic data may result in improved performance in applications that use synthetic data including simulation modelling and data testing. Further, the techniques described herein may be used to evaluate data to determine whether the data is real-world data, valid synthetic data, or fraudulent data that is being presented as real-world data. The disclosed technology may allow for a wide variety of benefits and advantages that enhance the efficiency of determining the quality of synthetic data.

Determining the quality of synthetic data allows for the determination of higher quality synthetic data that may be used in a variety of ways including simulation and/or modelling that uses the synthetic data in lieu of non-synthetic data (e.g., real world data that is not artificially generated). Further, distinguishing between synthetic data and non-synthetic or between higher quality synthetic data and lower quality synthetic data may allow the selection of the higher quality synthetic data that allows for more accurate results when performing simulations or generating models. Determining whether synthetic data is suitable for use in lieu of non-synthetic data may be based on an analysis of the extent to which the synthetic data and the non-synthetic data are similar at a distributional level. That is, a determination may be made of whether samples of the synthetic data and non-synthetic data appear to come from the same underlying distribution. For one dimensional data Q-Q plots, a Kolmogorov-Smirnov Test (continuous data), and/or a Chi-squared Test (categorical data) may be used. However, analysis, processing, and validation of multidimensional data (e.g., a loan record or derivative contract) may benefit from the novel solution described herein in which aspects of machine learning models (e.g., generative adversarial networks (GANs)) may be used to process and validate synthetic data and/or detect fraudulent data.

A machine learning model (e.g., a GAN) may use samples from an empirical distribution (e.g., non-synthetic data) and operate as a simulation engine that generates synthetic data samples after training on non-synthetic data. The GAN may comprise a generative machine learning model (e.g., a multi-layer neural network) that is trained to generate synthetic data. The GAN may further comprise a discriminative machine learning model (e.g., a discriminator) that is trained to distinguish synthetic data from non-synthetic data. Training the GAN may comprise minimizing a cost function that represents the likelihood of the discriminative machine learning model correctly identifying the samples when randomly shown examples of synthetic data or non-synthetic data. The cost function or objective function used for training (e.g., using a gradient descent methodology) the discriminative machine learning model may be given as:

$$J ( D ) = - \frac{1}{n + m} {\sum }_{i = 1}^{n + m} \frac{n + m}{2 n} {y}_{i} log D ( {x}_{i} ) + \frac{n + m}{2 m} ( 1 - {y}_{i} ) log ( 1 - D ( {x}_{i} ) ) \qquad Equation ( 1 )$$

where D(xᵢ), in a range [0,1], may be the output from the discriminative machine learning model representing the probability that a sample xᵢ came from real dataset (e.g., non-synthetic data). n may be the quantity of samples of non-synthetic data. m may be the quantity of samples of synthetic data. xᵢ may be the vector representing the samples (non-synthetic or synthetic) and yᵢ may be the labels used for training the discriminative machine learning model. For example, if xᵢ is a non-synthetic sample yᵢ=1, and if xᵢ is a synthetic sample, yᵢ=0.

As described herein, a training process used for the discriminative machine learning model may be leveraged to provide an estimate of a quality of synthetic data in a dataset comprising synthetic and non-synthetic data. For equally sized synthetic and non-synthetic datasets (i.e., n=m), Equation (1) may reduce to:

$$J ( D ) = - {\sum }_{i = 1}^{M} \frac{1}{M} {y}_{i} log D ( {x}_{i} ) + \frac{1}{M} ( 1 - {y}_{i} ) log ( 1 - D ( {x}_{i} ) ) \qquad Equation ( 2 )$$

where M=2n=2m is the total quantity of samples in the dataset comprising both synthetic and non-synthetic samples. Since yᵢ=1 for non-synthetic samples and yᵢ=0 for synthetic samples, Equation (2) may further reduce to:

$$J ( D ) = - {\sum }_{i = 1}^{M / 2} \frac{1}{M} log D ( {a}_{i} ) + \frac{1}{M} log ( 1 - D ( {b}_{i} ) ) \qquad Equation ( 3 )$$

where aᵢ represents the non-synthetic samples samples and bᵢ represents the synthetic samples.

Asymptotically, Equation (3) may be written as:

$$J ( D ) = - \frac{1}{2} \int q ( z ) log D ( z ) + p ( z ) log ( ( 1 - D ( z ) ) d z \qquad Equation ( 4 )$$

where q(z) is the probability distribution of non-synthetic samples and p(z) is the probability distribution of the synthetic samples. The integrand of Equation 4 may have a maximum value at:

$${D}^{*} ( z ) = \frac{q ( z )}{q ( z ) + p ( z )} .$$

This may define an optimal discriminator (e.g., for a given synthetic data generating function G).

$$J ( {D}^{*} ) = - \frac{1}{2} \int q ( z ) log ( \frac{2 q ( z )}{q ( z ) + p ( z )} ) + p ( z ) log ( \frac{2 p ( z )}{q ( z ) + {p}_{G} ( z )} ) dx + log 2$$

The value of the integration function is simply the Jensen-Shannon Entropy (or Jensen-Shannon divergence (JSD)) of the non-synthetic samples (with the probability distribution q(z)) and the synthetic samples (with the probability distribution p(z)). This may mean in particular that:

$$J ( {D}^{*} ) = - J S D ( q , p ) + log 2 \qquad Equation ( 5 )$$

$$J S D ( q , p ) = log 2 - J ( {D}^{*} )$$

If we determine D*(z), we may determine the JSD. JSD may provide a measure of similarity between the non-synthetic data with the probability distribution q(x) and the synthetic data with the probability distribution p(x). In other words, JSD may be a measure of the distance between the two probability distributions and may be a measure of a performance of the synthetic data generating function G and/or a measure of a quality of the non-synthetic data.

In practice, a discriminator D used may only be an approximation of the optimal discriminator D*. J̅S̅D̅(q, p) for a discriminator D may be a proxy for JSD(q, p) and may be given by:

$$\overline{J S D} ( q , p ) = log 2 - J ( D ) \qquad Equation ( 6 )$$

Since, J(D*)≤J(D), J̅S̅D̅(q, p) may be a lower bound of the actual Jensen-Shannon divergence JSD(q, p) and may be considered as an estimate of the actual Jensen-Shannon divergence JSD(q, p). That is,

$$\overline{J S D} ( q , p ) \leq J S D ( q , p ) \qquad Equation ( 7 )$$

J̅S̅D̅(q, p) values may be used for determining a quality of synthetic data in a dataset comprising both synthetic and non-synthetic data. Given a fixed quantity of training samples M, we may train multiple discriminative machine learning models to find the top performing discriminator. Here we may leverage the Hornik-Cybenko Theorem, which shows that any continuous function can be approximated arbitrarily closely by some network. Training the machine learning models may be carried out using gradient descent.

For each discriminator D and for a given quantity of training samples M, J̅S̅D̅(D), may be determined (e.g., based on Equations (3) and (6)). The determination may be repeated for increasing values of M until J̅S̅D̅(D) has converged. The highest value of J̅S̅D̅(D) (e.g., represented as J̅S̅D̅) among all the discriminators may be used as an estimate of the distance between the synthetic data and non-synthetic data and may be considered as a measure of the quality of non-synthetic data. For example,

$$\overline{J S D} = {max}_{D} \overline{J S D} ( D ) \qquad Equation ( 7 )$$

The J̅S̅D̅ may be in the range [0, log(2)]. Example results for a range of synthetic data samples, including non-synthetic data treated as synthetic, are shown below:

| Synthetic Data Quality | J̅S̅D̅ |
|---|---|
| Poor | 0.6 |
| Good | 0.25 |
| Perfect | 0.0 |

Leveraging the GAN calibration techniques described herein, we may determine distributional metrics and thus detect whether data is synthetic data. If the value of the J̅S̅D̅ is zero, the data may be determined to be non-synthetic data (e.g., a value of zero indicates that the distributions of the data samples are the same).

As described above, because the determined D is not necessarily optimal, J̅S̅D̅ is a lower bound to JSD(q, p). Further, it may be assumed that the (Monte Carlo) sum approximation to the expectations has reasonably converged. However, the disclosed technology provides various advantages including determining distributional similarity based on samples without having to make distributional assumptions. Further, the disclosed technology may operate on tables of data with any number of columns. Further, the computed metric may serve as a data quality score of synthetic data, allowing generators that generated the synthetic data to be compared and identifying fraudulent or low quality synthetic data.

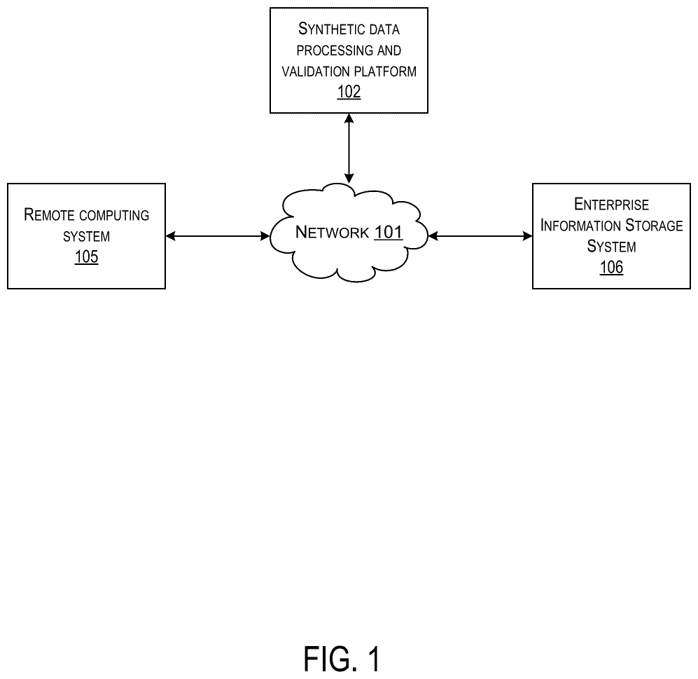

FIG. 1 depicts an example of a computing environment for automated processing and validation of synthetic data in accordance with one or more example embodiments. Referring to FIG. 1, computing environment 100 may include one or more computing systems. For example, computing environment 100 may include synthetic data processing and validation platform 102, remote computing system 105, and enterprise information storage system 106.

As described further below, synthetic data processing and validation platform 102 may comprise a computing system that includes one or more computing devices (e.g., computing devices comprising one or more processors, one or more memory devices, one or more storage devices, and/or communication interfaces) that may be used to process and/or validate synthetic data. For example, the synthetic data processing and validation platform 102 may be configured to implement one or more machine learning models that may be configured and/or trained to receive synthetic data and generate a data quality score that indicates the extent to which the synthetic data is similar to non-synthetic data (e.g., non-synthetic data that is based on real-world information that was not artificially generated). In some implementations, the one or more machine learning models may be configured and/or trained to determine a probability that data (e.g., test data) is fraudulent. Further, the synthetic data processing and validation platform may be used to train one or more machine learning models (e.g., neural networks) to perform the operations described herein including generating a data quality score and/or detecting fraudulent data.

Remote computing system 105 may comprise one or more computing devices computing devices comprising one or more processors, one or more memory devices, one or more storage devices, and/or communication interface that may be configured to use synthetic data that may be validated by the synthetic data processing and validation platform 102. For example, the remote computing system 105 may use validated synthetic data (e.g., synthetic data that is determined not to be fraudulent and that has a data sample distribution with a low Jensen-Shannon divergence value) to perform a variety of operations including executing simulations (e.g., simulations of financial transactions) and/or testing applications (e.g., testing financial applications using synthetic data in lieu of non-synthetic data).

Enterprise information storage system 106 may comprise a computing system that includes one or more computing devices (e.g., servers, server blades, or the like) and/or other computer components (e.g., one or more processors, one or more memory devices, and/or one or more communication interfaces) that may be used to store historical synthetic data and/or training data. For example, the enterprise information storage system 106 may store records of financial transactions, consumer account information, consumer credit histories, and/or consumer information (e.g., address and/or phone number).

Computing environment 100 may include one or more networks, which may interconnect synthetic data processing and validation platform 102, remote computing system 105, and/or enterprise information storage system 106. For example, computing environment 100 may include a network 101 (which may interconnect, e.g., synthetic data processing and validation platform 102, remote computing system 105, and/or enterprise information storage system 106). In some instances, the network 101 may comprise a 5G data network, and/or other data network.

In one or more arrangements, synthetic data processing and validation platform 102, remote computing system 105, and/or enterprise information storage system 106 may comprise any type of computing device capable of sending and/or receiving data and processing the data accordingly. For example, synthetic data processing and validation platform 102, remote computing system 105, enterprise information storage system 106, and/or the other systems included in computing environment 100 may, in some instances, include server computers, desktop computers, laptop computers, tablet computers, smart phones, or the like that may include one or more processors, one or more memory devices, communication interfaces, one or more storage devices, and/or other components. As noted above, and as illustrated in greater detail below, any combination of synthetic data processing and validation platform 102, remote computing system 105, and/or enterprise information storage system 106, may, in some instances, be special-purpose computing devices configured to perform specific functions. For example, synthetic data processing and validation platform 102 may comprise one or more application specific integrated circuits (ASICs) that are configured to process synthetic data, implement one or more machine learning models, and/or determine Jensen-Shannon divergence values based on analysis of the synthetic data.

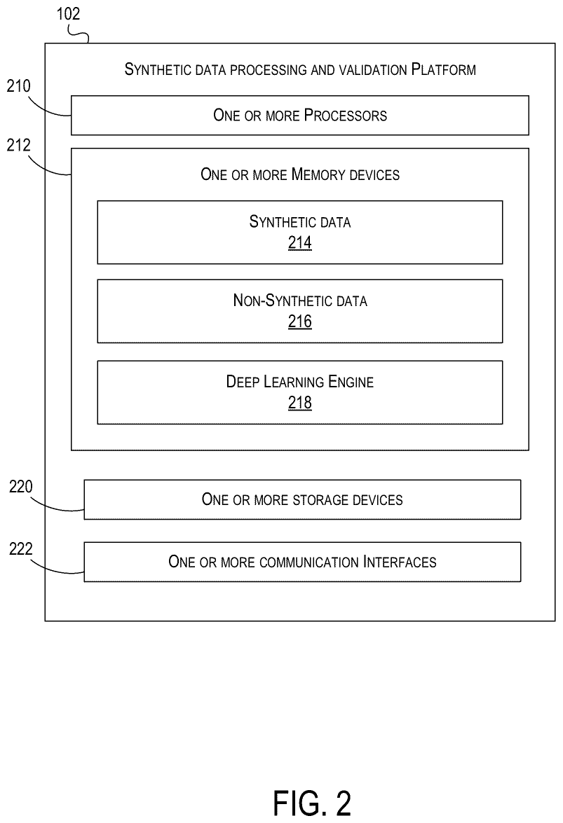

FIG. 2 depicts an illustrative computing platform for automated processing and validation of synthetic data in accordance with one or more aspects of the disclosure. Synthetic data processing and validation platform 102 may include one or more processors (e.g., processor 210), one or more memory devices 212, and a communication interface (e.g., one or more communication interfaces 222). A data bus may interconnect the processor 210, one or more memory devices 212, one or more storage devices 220, and/or one or more communication interfaces 222. One or more communication interfaces 222 may be configured to support communication between synthetic data processing and validation platform 102 and one or more networks (e.g., network 101, or the like). One or more communication interfaces 222 may be communicatively coupled to the one or more processor 210. The memory may include one or more program modules having instructions that when executed by one or more processor 210 cause synthetic data processing and validation platform 102 to perform one or more functions described herein and/or one or more databases that may store and/or otherwise maintain information which may be used by such program modules and/or one or more processors 210. In some instances, the one or more program modules and/or databases may be stored by and/or maintained in different memory units of synthetic data processing and validation platform 102 and/or by different computing devices that may form and/or otherwise make up synthetic data processing and validation platform 102. For example, the memory may have, host, store, and/or include synthetic data 214, synthetic data discriminator module 216, and/or deep learning engine 218. One or more storage devices 220 (e.g., solid state hard drives and/or hard disk drives) may also be used to store data including the synthetic data. The one or more storage devices 220 may comprise non-transitory computer readable media that may store data when the one or more storage devices 220 are in an active state (e.g., powered on) or an inactive state (e.g., sleeping or powered off).

Synthetic data 214 may comprise synthetic data from one or more sources (e.g., a machine learning algorithm, a database, etc.). The synthetic data 214 may comprise one or more synthetic data samples. Non-synthetic data 216 may comprise real-world data that was not artificially generated. For example, the non-synthetic data 216 may comprise financial records, transaction records, and/or consumer information. Deep learning engine 218 may implement, refine, train, maintain, and/or otherwise host an artificial intelligence model (e.g., one or more machine learning models) that may be used to process, analyze, evaluate, and/or validate data including synthetic data as described herein. Further, deep learning engine 218 may comprise a discriminative machine learning model that comprises one or more instructions to generate a data quality score and/or detect fraudulent synthetic data as described herein.

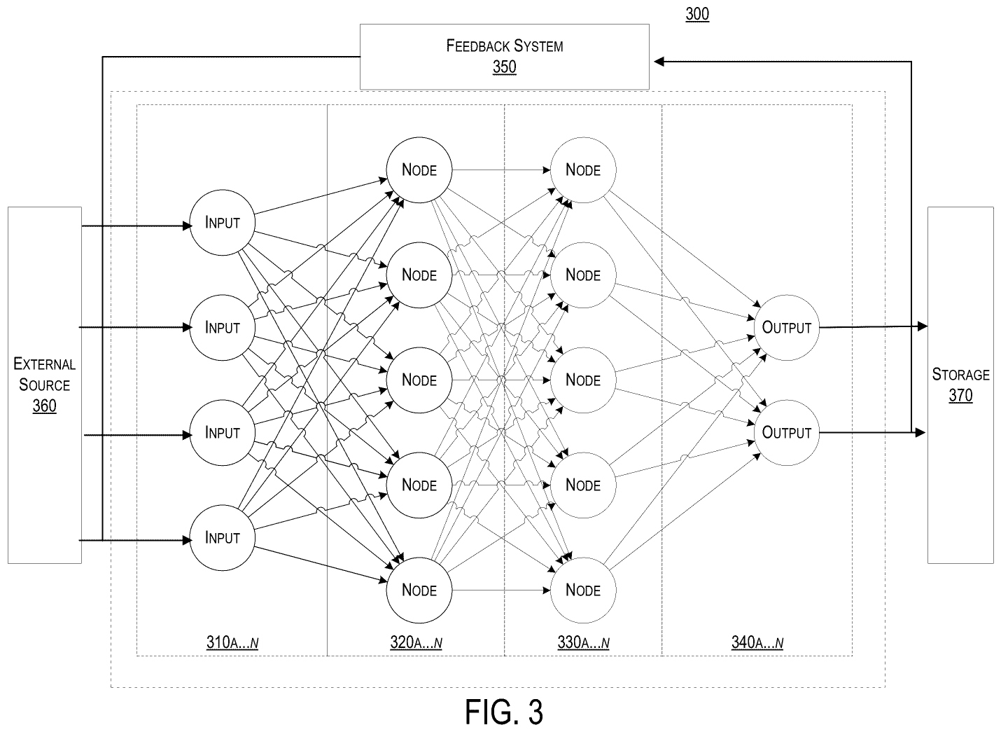

FIG. 3 depicts an illustrative artificial neural network on which a machine learning algorithm may be implemented in accordance with one or more aspects of the disclosure. In FIG. 3, each of input nodes 310a-n may be connected to a first set of processing nodes 320a-n. Each of the first set of processing nodes 320a-n may be connected to each of a second set of processing nodes 330a-n. Each of the second set of processing nodes 330a-n may be connected to each of output nodes 340a-n. Though only two sets of processing nodes are shown, any number of processing nodes may be implemented. Similarly, though only four input nodes, five processing nodes, and two output nodes per set are shown in FIG. 3, any number of nodes may be implemented per set. Data flows in FIG. 3 are depicted from left to right: data may be input into an input node, may flow through one or more processing nodes, and may be output by an output node. Input into the input nodes 310a-n may originate from an external source 360. Output may be sent to a feedback system 350 and/or to storage 370. The feedback system 350 may send output to the input nodes 310a-n for successive processing iterations with the same or different input data.

In one illustrative method using feedback system 350, the system may use machine learning to determine an output. The system may use any machine learning model including one or more XGBoosted decision trees, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) defining a loss function that serves as an accurate measure to evaluate the machine learning model's performance, (2) minimizing the loss function, such as through a gradient descent algorithm or other algorithms, and/or (3) optimizing a sampling method, such as using a stochastic gradient descent (SGD) method where instead of feeding an entire dataset to the machine learning algorithm for the computation of each step, a subset of data is sampled sequentially. In one example, optimization comprises minimizing the number of false positives. Alternatively, an optimization function may minimize the number of missed positives to optimize minimization of losses from exploits.

In one example, FIG. 3 depicts nodes that may perform various types of processing, such as discrete computations, computer programs, and/or mathematical functions implemented by a computing device. For example, the input nodes 310a-n may comprise logical inputs of different data sources, such as one or more data servers. The processing nodes 320a-n may comprise parallel processes executing on multiple servers in a data center. And, the output nodes 340a-n may be the logical outputs that ultimately are stored in results data stores, such as the same or different data servers as for the input nodes 310a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 300 may learn and/or be dynamically reconfigured. Though nodes are depicted as having connections only to successive nodes in FIG. 3, connections may be formed between any nodes. For example, one processing node may be configured to send output to a previous processing node.

Input received in the input nodes 310a-n may be processed through processing nodes, such as the first set of processing nodes 320a-n and the second set of processing nodes 330a-n. The processing may result in output in output nodes 340a-n. As depicted by the connections from the first set of processing nodes 320a-n and the second set of processing nodes 330a-n, processing may comprise multiple steps or sequences. For example, the first set of processing nodes 320a-n may be a rough data filter, whereas the second set of processing nodes 330a-n may be a more detailed data filter.

The artificial neural network 300 may be configured to effectuate decision-making. As a simplified example for the purposes of explanation, the artificial neural network 300 may be configured to generate a data quality score associated with an extent to which synthetic data is similar to non-synthetic data that comprises one or more features of the synthetic data. The input nodes 310a-n may be provided with synthetic data. The first set of processing nodes 320a-n may be each configured to perform specific steps to analyze the synthetic data, such as identifying synthetic data samples of the synthetic data that have been duplicated. The second set of processing nodes 330a-n may be each configured to analyze the distribution of the synthetic data samples of the synthetic data. Multiple subsequent sets may further refine this processing, each looking for further more specific tasks, with each node performing some form of processing which need not necessarily operate in the furtherance of that task. The artificial neural network 300 may then generate a data quality score. The data quality score and/or Jensen-Shannon divergence value may indicate the extent to which the synthetic data is similar to non-synthetic data.

The feedback system 350 may be configured to determine the accuracy of the artificial neural network 300. For example, in the synthetic data analysis example provided above, the feedback system 350 may be configured to determine an average accuracy of Jensen-Shannon divergence values that are generated for multiple portions of synthetic data. The feedback system 350 may comprise human input, such as an administrator telling the artificial neural network 300 whether it made a correct decision. The feedback system may provide feedback (e.g., an indication of whether the previous output was correct or incorrect) to the artificial neural network 300 via input nodes 310a-n or may transmit such information to one or more nodes. The feedback system 350 may additionally or alternatively be coupled to the storage 370 such that output is stored. The feedback system may not have correct answers at all, but instead base feedback on further processing: for example, the feedback system may comprise a system programmed to analyze and validate synthetic data, such that the feedback allows the artificial neural network 300 to compare its results to that of a manually programmed system.

The artificial neural network 300 may be dynamically modified to learn and provide better input. Based on, for example, previous input and output and feedback from the feedback system 350, the artificial neural network 300 may modify itself. For example, processing in nodes may change and/or connections may be weighted differently. Additionally or alternatively, the node may be reconfigured to process synthetic data differently. The modifications may be predictions and/or guesses by the artificial neural network 300, such that the artificial neural network 300 may vary its nodes and connections to test hypotheses.

The artificial neural network 300 need not have a set number of processing nodes or number of sets of processing nodes, but may increase or decrease its complexity. For example, the artificial neural network 300 may determine that one or more processing nodes are unnecessary or should be repurposed, and either discard or reconfigure the processing nodes on that basis. As another example, the artificial neural network 300 may determine that further processing of all or part of the input is required and add additional processing nodes and/or sets of processing nodes on that basis.

The feedback provided by the feedback system 350 may be mere reinforcement (e.g., providing an indication that output is correct or incorrect, awarding the machine learning algorithm a number of points, or the like) or may be specific (e.g., providing the correct output). For example, the artificial neural network 300 may be used to determine a probability that synthetic data is fraudulent. Based on an output, the feedback system 350 may indicate a score (e.g., 80% accuracy, an indication that the predicted probability was accurate, or the like) or a specific response (e.g., specifically identifying whether synthetic data is fraudulent).

The artificial neural network 300 may be supported or replaced by other forms of machine learning. For example, one or more of the nodes of artificial neural network 300 may implement a decision tree, associational rule set, logic programming, regression model, cluster analysis mechanisms, Bayesian network, propositional formulae, generative models, and/or other algorithms or forms of decision-making. The artificial neural network 300 may effectuate deep learning.

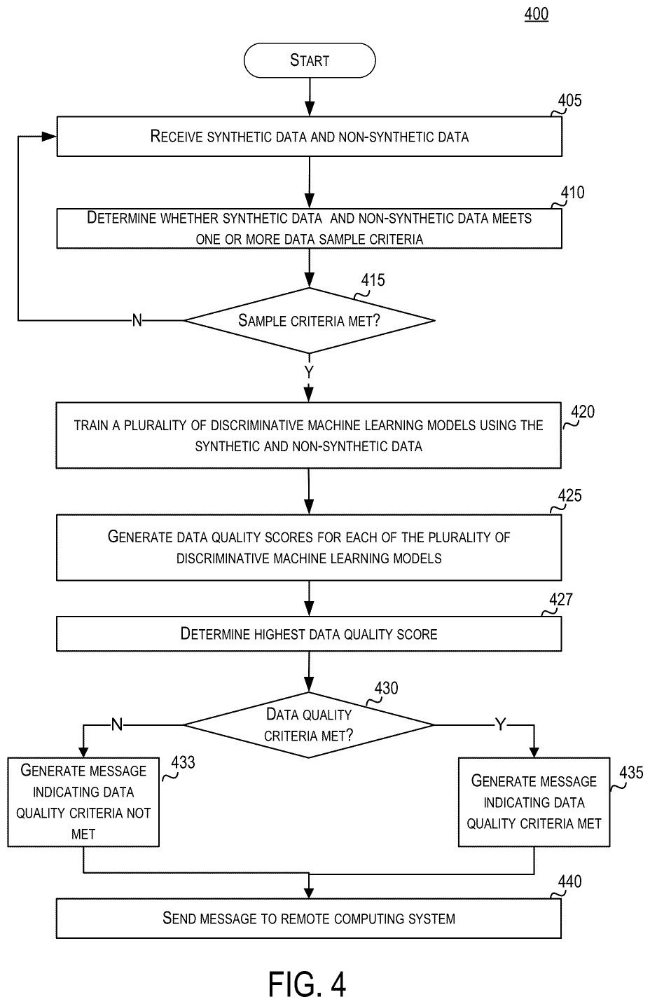

FIG. 4 depicts an illustrative method for automated processing and evaluation of synthetic data in accordance with one or more example embodiments. The steps of the method for automated processing and evaluation of synthetic data may be implemented by a computing device or computing system (e.g., the synthetic data analysis and validation platform 102) in accordance with the computing devices and/or computing systems described herein.

At step 405, a computing system may receive synthetic data and non-synthetic data. The synthetic data may comprise a plurality of synthetic data samples. The non-synthetic data may comprise a plurality of non-synthetic data samples. For example, a computing system (e.g., the synthetic data analysis and validation platform 102) may receive synthetic data and non-synthetic data from a remote data source (e.g., a third-party provider of synthetic data for use by other entities), in local memory (e.g., the one or more memory devices 212 of the synthetic data analysis and validation platform 102), and/or local storage (e.g., the one or more storage devices 220 of the synthetic data analysis and validation platform 102).

At step 410, a computing system may determine, based on one or more features of the data (e.g., synthetic data and non-synthetic data), whether the data meets one or more data sample criteria associated with validity of the data as an input to a machine learning model. For example, a computing system (e.g., the synthetic data analysis and validation platform 102) may analyze the data and compare the number of the plurality of data samples to a threshold number of data samples in order to determine whether the number of the plurality of data samples exceeds the threshold.

Based on data meeting the one or more sample criteria at step 415, step 420 may be performed. For example, a computing system (e.g., the synthetic data analysis and validation platform 102) may analyze the data and determine based on the number of the plurality of data samples exceeding a threshold number of data samples, that the one or more data sample criteria have been met. Based on the data not meeting the one or more sample criteria, step 405 may be performed. For example, a computing system (e.g., the synthetic data analysis and validation platform 102) may analyze the data and determine (e.g., the number of the plurality of synthetic data samples not exceeding the threshold number of synthetic data samples) that the one or more data sample criteria have not been met. Based on the one or more data sample criteria not being met, the computing system may request additional data samples for processing.

At step 420, a computing system may, based on the data meeting the one or more data sample criteria, train, a plurality of discriminative machine learning models based on training using the synthetic data and non-synthetic data. The synthetic data and non-synthetic data may be pre-processed prior to be being used for training the plurality of discriminative machine learning models.

For example, the synthetic data samples and non-synthetic data samples may correspond to respective tabular datasets. Data types associated with the datasets may be one or more of numerical, Boolean, categorical, datetime, etc. The individual rows in both datasets are considered to be independent observations from a multivariate distribution. The following transformations may be applied:
Numerical data: standardization to 0 mean, unit variance
Categorical data: transformation into one-hot encoding
Boolean data: transformation into one-hot encoding
Datetime data: transformation into numerical values representing time since an epoch, then application of standardization as for numerical data
   Label 0 may be added to the synthetic data samples, label 1 may be added to the non-synthetic data samples. The above transformations are merely exemplary, but the example techniques described herein are not limited to these transformations. Additionally, or alternatively, a user may apply (e.g., via the remote computing system 105) custom transformations to the data samples. The same transformations are applied to both the non-synthetic and synthetic datasets.

The labelled datasets are concatenated into one and a plurality of discriminative machine learning models (e.g., binary classifiers) may be selected/specified by the user. The discriminative machine learning models may have increasing discriminative power (e.g., number of neurons in neural network). The discriminative machine learning models may then be iteratively trained to classify the real and synthetic samples (e.g., 1 and 0) using the labelled datasets.

At step 425, a computing system may generate respective data quality scores for each of the plurality of discriminative machine learning models. A data quality score may be associated with an extent to which the synthetic data is similar to non-synthetic data comprising the one or more features of the synthetic data.

For example, cost values for each of the plurality of discriminative machine learning models may be determined using the labelled sets of synthetic data samples and non-synthetic data samples. For example, the cost values may be determined based on applying equations (1), (2), or (3) as described above. The computing system may further determine respective data quality scores (e.g., J̅S̅D̅) based on the respective cost values for each of the discriminative machine learning models. The data quality scores may be determined based on Equation (6) and may be an estimate of Jensen-Shannon divergence value associated with the synthetic data samples and non-synthetic data samples.

For example, sub-samples of increasing size from the concatenated non-synthetic and synthetic dataset may be generated. For each discriminative machine learning model, the computing system may determine J̅S̅D̅ with increasing sample size. For each discriminative machine learning model, the computing system may determine whether convergence of J̅S̅D̅ is achieved with increasing sample size. The converged value of J̅S̅D̅ may be considered as a data quality score as determined based on the discriminative machine learning model. It may be noted that the convergence of the J̅S̅D̅ may be achieved when the corresponding cost value is converged.

At step 427, the computing system (e.g., the synthetic data analysis and validation platform 102) may determine a highest data quality score among data quality scores generated for each of the plurality of discriminative machine learning models.

At step 430, on the computing system (e.g., the synthetic data analysis and validation platform 102) may determine whether the synthetic data meets one or more data quality criteria. For example, the computing system may analyze a data quality score (e.g., the highest data quality score as determined at step 427) and determine based on the data quality score not exceeding a threshold data quality score, that the one or more data quality criteria have been met. For example, the computing system (e.g., the synthetic data analysis and validation platform 102) analyze the data quality score and determine based on the data quality score exceeding the threshold data quality score, that the one or more data quality criteria have not been met.

At step 433, the computing system may, based on the data quality score not meeting one or more data quality criteria, generate a message comprising an indication that the synthetic data has not satisfied one or more data quality criteria associated with validity of the synthetic data to test performance of one or more applications. For example, a computing system (e.g., the synthetic data analysis and validation platform 102) may generate a message indicating that “THE SYNTHETIC DATA IS NOT SUFFICIENTLY SIMILAR TO REAL-WORLD DATA.”

At step 435, the computing system may, based on the data quality score meeting one or more data quality criteria, generate a message comprising an indication that the synthetic data has satisfied one or more data quality criteria associated with validity of the synthetic data to test performance of one or more applications. For example, a computing system (e.g., the synthetic data analysis and validation platform 102) may generate a message indicating that “THE SYNTHETIC DATA IS SUFFICIENTLY SIMILAR TO REAL-WORLD DATA.”

At step 440, a computing system may send the message to a remote computing system that uses the synthetic data to test performance of one or more applications. For example, a computing system (e.g., the synthetic data analysis and validation platform 102) may send the message that “THE SYNTHETIC DATA IS SUFFICIENTLY SIMILAR TO REAL-WORLD DATA” to a remote computing system 104 that is used to simulate financial transactions using synthetic data. Based on receiving the message, the remote computing system 104 may use the synthetic data.

For example, a computing system (e.g., the synthetic data analysis and validation platform 102) may send the message that “THE SYNTHETIC DATA IS NOT SUFFICIENTLY SIMILAR TO REAL-WORLD DATA” to a remote computing system 104 that is used to simulate financial transactions using synthetic data. Based on receiving the message, the remote computing system 104 may not use the synthetic data.

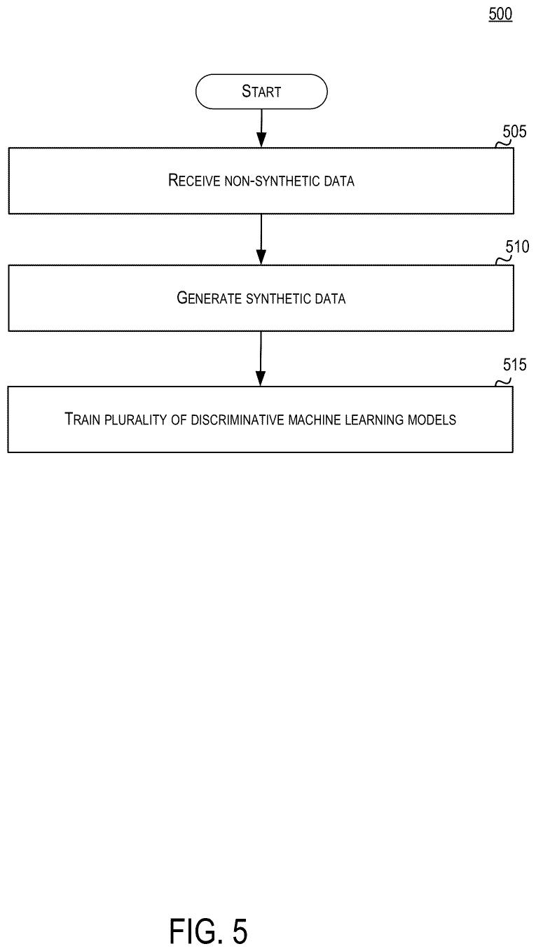

FIG. 5 depicts an illustrative method 500 for iteratively training the discriminative machine learning models in accordance with one or more example embodiments. The steps of the method for training machine learning models may be implemented by a computing device or computing system (e.g., the synthetic data analysis and validation platform 102) in accordance with the computing devices and/or computing systems described herein. One or more steps of the method for training machine learning models may be implemented as part of the method for automated processing and evaluation of synthetic data that is described with respect to FIG. 4 (e.g., step 420).

At step 505, a computing system may receive non-synthetic training data comprising a plurality of non-synthetic data samples based on a plurality of real world information. For example, a computing system (e.g., the synthetic data analysis and validation platform 102) may receive non-synthetic data that has been encrypted and anonymized to preserve the security and privacy of the real-world sources on which the non-synthetic data is based.

At step 510, a computing system may generate, based on inputting the non-synthetic training data into one or more generative machine learning models, synthetic training data comprising a plurality of synthetic training data samples. For example, the synthetic data analysis and validation platform 102 may comprise a generative adversarial network that includes discriminative machine learning models and generative machine leaning models that are configured and/or trained to generate synthetic training data that may have a similar distribution to non-synthetic training data that is provided as an input. While the example method 500 describes generation of synthetic data based on non-synthetic data using a generative machine learning model, the various techniques described herein with respect to generation of data quality scores may apply to any type of synthetic data (e.g., that is not necessarily generated using a generative machine learning model). In at least some examples, the synthetic training data may be from another source (e.g., a database). In such scenarios, step 510 may be omitted and the computing system may simply operate on synthetic training data and non-synthetic training data in accordance with step 525 below.

At step 525, a computing system may iteratively train the plurality of discriminative machine learning models to distinguish between synthetic data and non-synthetic data. Training the plurality of discriminative machine learning models may comprise minimizing a cost (e.g., as determined using equation (1)). For example, over a plurality of training iterations, a weighting of one or more parameters of the plurality of discriminative machine learning models may be modified based on the extent to which the one or more parameters contribute to minimizing the cost resulting from a cost function. Over the plurality of training iterations, the plurality of discriminative machine learning models may become more effective at distinguishing between the synthetic data and non-synthetic data on which the synthetic data is based.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing system comprising:
one or more processors; and
memory storing computer-readable instructions that, when executed by the one or more processors, cause the computing system to:
receive data comprising:
synthetic data comprising a plurality of synthetic data samples; and
non-synthetic data comprising a plurality of non-synthetic data samples;
generate, based on inputting the data into a plurality of discriminative machine learning models, a plurality of data quality scores associated with an extent to which the synthetic data is similar to the non-synthetic data, wherein each of the data quality scores provides an estimate of a similarity between a distribution of the plurality of synthetic data samples and a distribution of the plurality of non-synthetic data samples;
determine a highest data quality score from the plurality of data quality scores;
based on the highest data quality score, generate a message comprising an indication whether the synthetic data has satisfied one or more data quality criteria associated with validity of the synthetic data to test performance of one or more applications; and
send the message to a remote computing system that uses the synthetic data to test performance of one or more applications.

2. The computing system of claim 1, wherein the computer-readable instructions, when executed by the one or more processors, further cause the computing system to generate the plurality of data quality scores by causing generating a data quality score, of the plurality of data quality scores, by:
determining, based on applying a cost function to the discriminative machine learning model, a cost value associated with the discriminative machine learning model.

3. The computing system of claim 2, wherein the cost value is a converged cost value that is determined based on applying increasing quantity of data samples to the discriminative machine learning model.

4. The computing system of claim 3, wherein the data quality score is an estimate of a Jensen-Shannon divergence value for the synthetic data and the non-synthetic data, and wherein the data quality score is positively correlated with a probability that the synthetic data is not similar to the non-synthetic data.

5. The computing system of claim 1, wherein the computer-readable instructions, when executed by the one or more processors, further cause the computing system to iteratively train a discriminative machine learning model, of the plurality of discriminative machine learning models, based on the synthetic data samples and the non-synthetic data samples.

6. The computing system of claim 1, wherein the non-synthetic data is based on one or more real world financial transactions, one or more consumer real world consumer account details, or one or more real world consumer credit histories.

7. The computing system of claim 1, wherein the non-synthetic data is based on real world information, and wherein the computer-readable instructions, when executed by the one or more processors, cause the computing system to:
generate, based on inputting the non-synthetic data into one or more generative machine learning models, the synthetic data.

8. The computing system of claim 1, wherein the synthetic data and the non-synthetic data comprises multidimensional tabular data.

9. The computing system of claim 1, wherein each of the plurality of data quality scores corresponds to a lower bound of an actual Jensen-Shannon divergence value associated with the synthetic data and the non-synthetic data.

10. The computing system of claim 1, wherein the synthetic data satisfying the one or more data quality criteria comprises the highest data quality score being below a threshold data quality score.

11. The computing system of claim 1, wherein the computer-readable instructions, when executed by the one or more processors, cause the computing system to:
perform, using the synthetic data and based on the synthetic data satisfying the one or more data quality criteria, one or more operations for simulation modelling or fraud detection.

12. A method comprising:
receiving data comprising:
synthetic data comprising a plurality of synthetic data samples; and
non-synthetic data comprising a plurality of non-synthetic data samples;
generating, based on inputting the data into a plurality of discriminative machine learning models, a plurality of data quality scores associated with an extent to which the synthetic data is similar to the non-synthetic data, wherein each of the data quality scores provides an estimate of a similarity between a distribution of the plurality of synthetic data samples and a distribution of the plurality of non-synthetic data samples;
determining a highest data quality score from the plurality of data quality scores;
based on the highest data quality score, generating a message comprising an indication whether the synthetic data has satisfied one or more data quality criteria associated with validity of the synthetic data to test performance of one or more applications; and
sending the message to a remote computing system that uses the synthetic data to test performance of one or more applications.

13. The method of claim 12, wherein the generating the plurality of data quality scores comprises generating a data quality score, of the plurality of data quality scores, by:
determining, based on applying a cost function to the discriminative machine learning model, a cost value associated with the discriminative machine learning model.

14. The method of claim 13, wherein the cost value is a converged cost value that is determined based on applying increasing quantity of data samples to the discriminative machine learning model.

15. The method of claim 13, wherein the data quality score is an estimate of a Jensen-Shannon divergence value for the synthetic data and the non-synthetic data, and wherein the data quality score is positively correlated with a probability that the synthetic data is not similar to the non-synthetic data.

16. The method of claim 12, further comprising iteratively training a discriminative machine learning model, of the plurality of discriminative machine learning models, based on the synthetic data samples and the non-synthetic data samples.

17. The method of claim 12, wherein the non-synthetic data is based on real world information, and wherein the method further comprises:
generating, based on inputting the non-synthetic data into one or more generative machine learning models, the synthetic data.

18. The method of claim 12, wherein each of the plurality of data quality scores corresponds to a lower bound of an actual Jensen-Shannon divergence value associated with the synthetic data and the non-synthetic data.

19. The method of claim 12, wherein the synthetic data satisfying the one or more data quality criteria comprises the highest data quality score being below a threshold data quality score.

20. A non-transitory computer readable medium storing instructions that, when executed, cause a computing platform to:
receive data comprising:
synthetic data comprising a plurality of synthetic data samples; and
non-synthetic data comprising a plurality of non-synthetic data samples;
generate, based on inputting the data into a plurality of discriminative machine learning models, a plurality of data quality scores associated with an extent to which the synthetic data is similar to the non-synthetic data, wherein each of the data quality scores provides an estimate of a similarity between a distribution of the plurality of synthetic data samples and a distribution of the plurality of non-synthetic data samples;
determine a highest data quality score from the plurality of data quality scores;
based on the highest data quality score, generate a message comprising an indication whether the synthetic data has satisfied one or more data quality criteria associated with validity of the synthetic data to test performance of one or more applications; and
send the message to a remote computing system that uses the synthetic data to test performance of one or more applications.
